(19) United States
(12) Patent Application Publication
(10) Pub. No.: US 2013/0127601 A1
(43) Pub. Date: May 23, 2013

(54) RFID Reader Using Single System on a Chip

(71) Applicant: Larry D. Thomas, JR., (US)

(72) Inventor: Larry D. Thomas, JR., (US)

(21) Appl. No.: 13/675,003

(22) Filed: Nov. 13, 2012

Related U.S. Application Data
(60) Provisional application No. 61/629,401, filed on Nov. 17, 2011.

(51) Int. Cl. G06K 7/01

(52) U.S. Cl. CPC G06K 7/01
USPC 340/10.51

(57) ABSTRACT

The invention is the method and timing sequence for a Reader and\or Writing of RFID Tags (Radio Frequency Identification device), utilizing the various functional components of a single System on a Chip (SoC) as a hardware platform. Extended functions are possible from this baseline function that can cover the full function of an RFID Reader/Writer.

The baseline function of this invention is “reading” (interrogating) and “writing” (loading) the EPC code from a passive RFID or active RFID tag by utilization of existing SoC hardware functions (microprocessor, memory and direct multi-port memory controller, and radio transmitter) and small amount of external circuitry (backscatter detector) along with in depth knowledge of the RFID protocol and timing to implement communications protocol. The end benefit is a much simpler hardware platform, much less cost and much less physical space for an RFID Reader/Writer.

### BACKGROUND

A proof of concept (PoC) has been implemented and proven to work with commercially available EPC RFID tags based on the Gen2 protocol, the most common protocol at the UHF band (Ultra High Frequency band—860 MHz and 915 MHz). This PoC is implemented on a platform of a SoC with included radio transmitter that operates in the sub-1 gigaherts radio frequency band. An attached drawing illustrates the hardware configuration as well as the data flow path through the PoC firmware and hardware. Prior art uses a hardware architecture of a processor with internal or external memory with an external radio frequency (RF) transmitter (radio) and RF receiver, which is an alternate platform but significantly more expensive, requires many components and therefore more physical space (board space), as well as being significantly more complex to program.

There are a number of RFID frequencies available in commercially available RFID tags. This PoC was developed and demonstrated on the 915 MHz band but is adaptable to other bands. Existing Reader/Writers are much more complex and thus much more expensive and much larger. RFID tags in this band utilize a backscatter methodology. Backscatter is the tag's echoing the reader's carrier frequencies with additionally carries the amplitude modulated data that first identifies a tag is within RF rand of the reader and then the detailed date held in the tag's memory. This data is typically referred to as Electronic Product Code (EPC) which is the electronic alternative for UPC (Universal Product Code) bard codes. A RFID Reader/Writer must supply power to a passive RFID tag. Most tags are passive, meaning they requite an outside power supply to activate their electronics. A Constant Carrier from the Reader is the source of that power. The Reader will include an amplitude modulated command that is recognized by the tags within the RF range of the Reader while continuing to transmit a constant carrier to power the in range tag. There are protocol details that help isolate one tag, from a plurality of possible tags within the RF range, so only one tag responds with a 16-bit random number backscatter. This 16-bit number must first be detected by the Reader and then decoded and encode in a command structure to once again be transmitted to the tag. The tag then responds with the requested data contained in the tag's memory, typically this is the EPC. Additional protocol allows a more one-to-one communication link to be established that enables a larger number of interaction that operate in much the same sequence and electrical and RF method, where commands with constant carrier from the Reader to activate and prompt backscatter communications from the individual RFID tag.

### DISCLOSURE

This invention and proof is based on utilization of a single semiconductor System on a Chip (SoC) or microcomputer that in addition to a microprocessor, also includes writable memory with functionally independent memory with multi-port memory controller and functionally includes a Radio/Transmitter for transmitting the commands and constant carrier needed to facilitate the protocol to communicate with a passive RFID Tag. The microcomputer is programmed to also receive, interpret and respond to backscatter replies from a target RFID Tag (Gen2 protocol for example), using a minimal of external hardware to demodulate and convert modulated Radio Frequency (RF) data to digital signal data. There are “active RFID tags” that have their own power source and therefore much further RF range/distance. This same hardware can be programmed with different protocol to communicate with active RFID tags as well.

One important feature of the platform is the function components of a microcomputer or SoC comprised of a microprocessor/microcontroller with independent multi-port memory and RF transmitting radio functions. The novelty herein is using the multi-port memory to be preloaded by the processor with command data and the ability for the multi-port memory and Radio to transmit that preloaded data to the RFID Tag, without the involvement of the microprocessor which is preforming parallel tasks.

This invention is capable of all RFID Reader/Writer actions and commands using its SoC, including multi-port memory controller and RF transmitter. First the SoC contains a transmitter (also the transmitter can be external or have an external power amplifier) which supplies the tag power with a constant carrier at the needed frequency. Also, the processor will preload the memory which drives the transmitter with command data to initiate the communications with a tag. Timing is critical between the initial command and the detection of backscatter data returning from the tag. The backscatter is demodulated and voltage doubled in order to digitize the data contained in the backscatter. That data is fed to the the SoC through one or more digital data input pins. The processor with precise timing considerations decodes the data which is not a pure one-zero signal. This decoded data is then encoded, by the processor, as needed to be inserted in the next command need for the continued communications. This processor activity must continue without interruption and therefore the radio and memory suppling data to the radio must work independently from the processor. This is the requirement for a multi-port memory controller that can be loaded by the processor and also send data to the radio transmitter simultaneously.

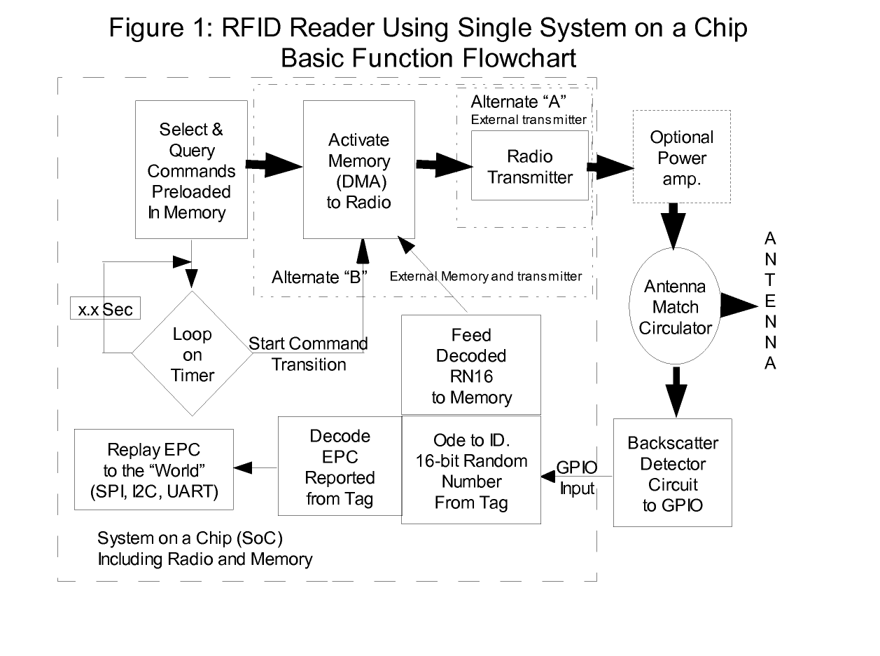

There are three possible configurations for this hardware platform platform. The three are illustrated in the attached drawing FIG. 1, by Alternate “A” and Alternate “B” configurations.

The basics of the RFID read function is: First, send a constant carrier at a particular radio frequency that supplies power to the Tag. Second, once the tag is powered, send the appropriate commands to activate the Tag to give a response in the form of “backscatter” radio signals. This backscatter contains a 16-bit random number, generated by the tag, that the reader must detect, decode and return as part of a protocol sequence, while continuing to feed power to the tag with an RF constant carrier. Finally, once the Tag receives the appropriate reply, based on the original 16-bit random number, the Tag will send its preprogrammed data, called EPC (Electronic Product Code). A variety of complexities extend from this basic function, such as RF collision avoidance and multiple tag cataloging. But all these are based on the communications protocol just described. Including writing (preprogramming) the EPC data to the tag which is an extension of this baseline function.

Prior RFID Readers are implemented in various formats but all require significant hardware as well as software functions. This invention uses a single SoC that also includes a microprocessor, a memory and controller with radio transmitter. The included radio is used to send the constant carrier (for tag power), the commands (to activate the tags communications protocol) and then the reply information based on the Random number set by the tag. The novelty of this invention is using GPIO pin(s) (analog or digital) to bring the backscatter communications protocol back into the processor while the memory and radio continue to power the tag with radio frequency without involvement of the processor. A phase split implementation would use two GPIO pins, one for each phase to facilitate phase tolerance of RF backscatter. This leaves the processor free to receive the backscatter data, decode it and reformat it to be sent back to the tag for communications hand-shakes that prompt the tag to send its EPC data.

The EPC data is then decoded and formatted to be sent to the next process (the “world”) through processor interfaces such as Serial Peripheral Interface (SPI), I2C, UART, digital serial data or parallel data as needed by the next process. Typically these interface to outside computers or microcomputer or microprocessor is a built-in function to most SoC and can be utilized to reduce system complexities, cost and physical electronic size.

Alternate hardware platforms can be used to implement this process. The memory and controller and or the radio transmitter can be external to the processor. These external functions must be able to function without the continuous attention of the microprocessor and continually transmit both a continuous carrier to power the tag but also the data that forms the commands to the tag while the processor receives, decodes and reformats the backscatter data coming from the RFID tag in parallel and real-time.

### DRAWING DESCRIPTION

An attached drawing illustrates the hardware configuration, as well as the data flow path through the PoC firmware and hardware. There are three possible configurations for this hardware platform platform. The three are illustrated in the attached drawing FIG. 1, by Alternate “A” and Alternate “B” configurations.

1. Radio Frequency Identification (RFID) Reader/Writer at various frequencies as needed for commercially available RFID tags, using a single System on a Chip (SoC) or microcomputer with direct multi-port memory controller, along with sub-one-gigahertz radio, along with minimal external hardware for backscatter decode and digitization to generate RFID communications protocol, both read/write data and timing (e.g. of SoC or microcomputer architecture most appropriate for this invention implementation are the Texas Instruments CC430, CC1110, CC1111 and CC1010 or AMD or other microcomputer with external Radio).

2. From claim 1, said “minimal external hardware for backscatter decode and digitization” may include two antennas or a circulater/coupler to a single antenna that can minimize complexity.

3. From claim 1, using said SoC or microcomputer with said direct multi-port memory controller, use the independent function of said direct multi-port memory controller to deliver input to said radio for Radio Frequency (RF) output for both constant carrier for tag power and command data for tag communications and interaction.

4. From claim 1 and claim 3, said direct multi-port memory controller can be preloaded with data from said SoC or microcomputer, as well as on-the-fly data loading from said SoC or microcomputer, to build the command data-strings and timing for RFID communications protocol through said radio without continuous follow on interaction from said SoC or microcomputer.

5. From claims 1, 3, and 4, using said direct multi-port memory controller for data transfer including timing to said radio for RF function will offload said SoC or microcomputer for data to said radio management thus focusing said SoC or microcomputer on decoding backscatter data from the RFID tag(s) as feed from said minimal external hardware for backscatter decode and digitization.

6. From claim 1, said sub-one-gigahertz radio can be internal to said SoC or microcomputer, with data feed from said direct multi-port memory controller.

7. From claim 1, said sub-one-gigahertz radio can be external to said SoC or microcomputer, with data feed from said direct multi-port memory controller.

8. From claim 1, said minimal external hardware for backscatter decode and digitization is a small circuit designed/tuned to or adjustable to the radio frequency of the RFID tags that demodulates the RFID backscatter allowing detection of the data within the modulated Radio Frequency (RF) and digitizing that data which is input to said SoC or microcomputer through one or more digital input ports of said SoC or microcomputer.

9. From claim 1, said SoC or microcomputer having a set of bus controllers such as USB, SPI, I2C and others, that can be used to communicate with Personal computers and/or other microcomputer or microprocessor for purpose of transferring read or received EPC and other data or writing EPC and other data to commercially available RFID tags.

10. From claim 1 said, said minimal external hardware for backscatter decode and digitization may have phase distinction capabilities for additional backscatter decode accuracy.

11. From claim 1, said sub-one-megahertz radio may have addition of Power Amplifiers to said radio output which may increase the range of RFID read/write functions.
